(19) United States
(12) Patent Application Publication
(10) Pub. No.: US 2009/0260662 A1
(43) Pub. Date: Oct. 22, 2009

(54) SPLASH CURTAIN FOR CONVEYOR WAREWASHER

(76) Inventors: Lisa R. Patton, Union, OH (US); Laura L. Snyder, Vandalia, OH (US)

Correspondence Address: THOMPSON HINE LLP;Intellectual Property Group, P.O Box 8801, DAYTON, OH, 45401-8801, US

(21) Appl. No.: 12/103,877

(22) Filed: Apr. 16, 2008

(51) Int. Cl. B08B 3/00; A47H 23/00

(52) U.S. Cl. 134/182; 160/184

(57) ABSTRACT

A conveyor warewasher includes splash curtains that function differently according to their orientation. The top connection part of the splash curtains and the connections mounted on the warewasher are designed to attach the curtain only when the curtain is hung in the proper orientation and not when the curtain is hung in reverse. A splash curtain for a warewasher includes functionally distinct front and rear sides. The arrangement of hook-receptive slots on the splash curtain is asymmetric so that the hook arrangement that they will receive differs when the curtain's orientation is reversed.

### TECHNICAL FIELD

This application relates generally to curtains for use in conveyor-type ware washing machines, and more specifically to a curtain configuration that assures proper orientation and placement of the curtain in a warewasher.

### BACKGROUND

Conveyor warewashers are used as an economical way to clean and sanitize dishes in a commercial environment. By providing a machine with multiple stations, each dedicated to a different step in the warewash cycle, it is possible to quickly and conveniently wash ware simply by allowing it to move through the washer.

Curtains are often used to separate different stations within the warewasher, as well as creating a barrier at the ware entrance and exit. The curtains contain the spray within each station, as well as retaining heat and aiding in the regulation of the temperature necessary to properly clean the ware.

Some curtains may have multiple layers of different lengths, to accommodate the movement of ware through the conveyer while leaving some layers intact. These curtains may not function as desired when hung backwards.

Different curtains may be hung at different places in the warewasher, and the curtains may not function as designed if their locations are juxtaposed.

It would be desirable to provide a warewasher curtain that prevents a backward attachment of the curtain to the warewasher. It would also be desirable to prevent a given curtain from being hung in a position intended for a different curtain.

### SUMMARY

In one aspect, a conveyer warewasher includes a housing with an internal station for spraying ware with liquid. A conveying system moves ware from an infeed end through the housing to an outfeed end. A curtain hangs across the conveyance path. The curtain functions differently if it is hung backwards. However, the top part of the curtain and connectors on the warewasher are configured so that they will not attach if the curtain is backwards.

In a further aspect, the warewasher also includes a second curtain that is functionally distinct from the first curtain. The two curtains are each designed so that they cannot be hung at the location intended for the other.

In another aspect, a splash curtain for a conveyer warewasher, configured for orientation-specific installation, includes a top connection part and flexible curtain material that hangs down from the top connection part to create a waterproof, insulating barrier. The curtain functions differently if it is hung backwards. However, the top connection part includes multiple slot-type openings, spaced asymmetrically along the curtain, for receiving hanger brackets. The result of the asymmetric configuration is that the connection arrangement when the curtain is facing front side forward is different than when the curtain is facing back side forward.

### BRIEF DESCRIPTION OF THE DRAWINGS

FIG. 1 is a side, angled view of a warewasher housing showing splash curtains in place;

FIG. 1A is a side elevation view of the unit of FIG. 1;

FIG. 2 is a side view of a long, layered splash curtain;

FIG. 2A shows the splash curtain pushed from the front by a ware object;

FIG. 2B shows the splash curtain pushed from the rear by a ware object;

FIG. 3 shows the top connection part of the long, layered splash curtain;

FIG. 4A shows the top connection part of FIG. 3 attached to warewasher connectors;

FIG. 4B shows the curtain and warewasher connectors of FIG. 4., with the curtain orientation reversed;

FIG. 5A shows the short splash curtain hung on its warewasher connectors;

FIG. 5B shows the short splash curtain of FIG. 5A with the warewasher connectors of FIG. 4; and

FIG. 5C shows the long, layered splash curtain of FIG. 4 with the warewasher connectors of FIG. 5A.

### DETAILED DESCRIPTION

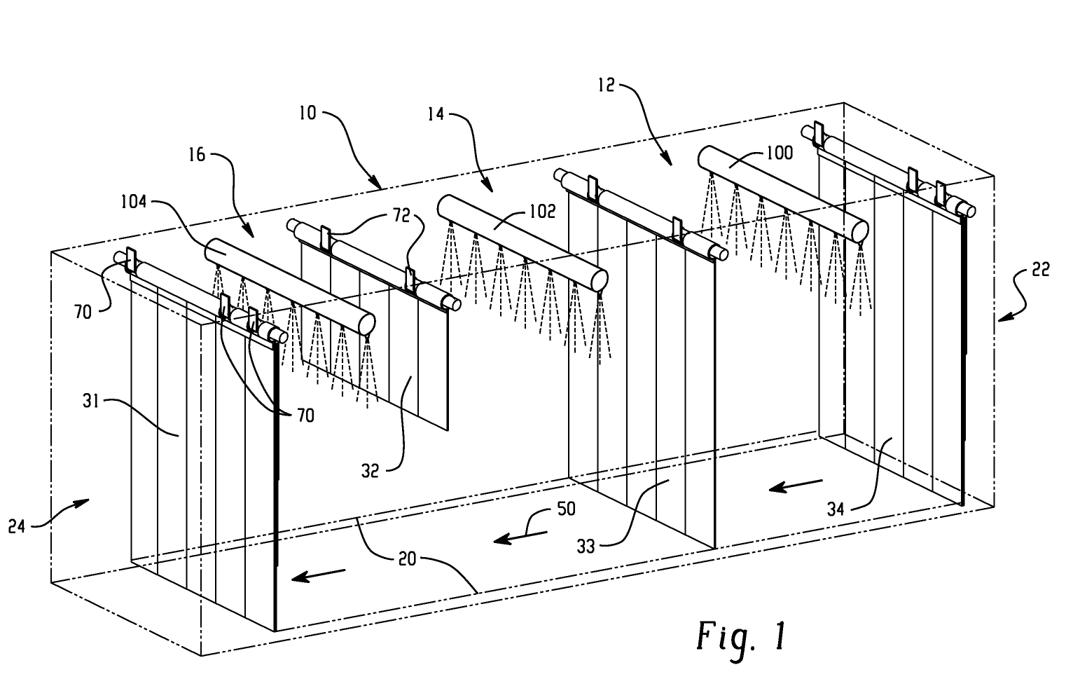

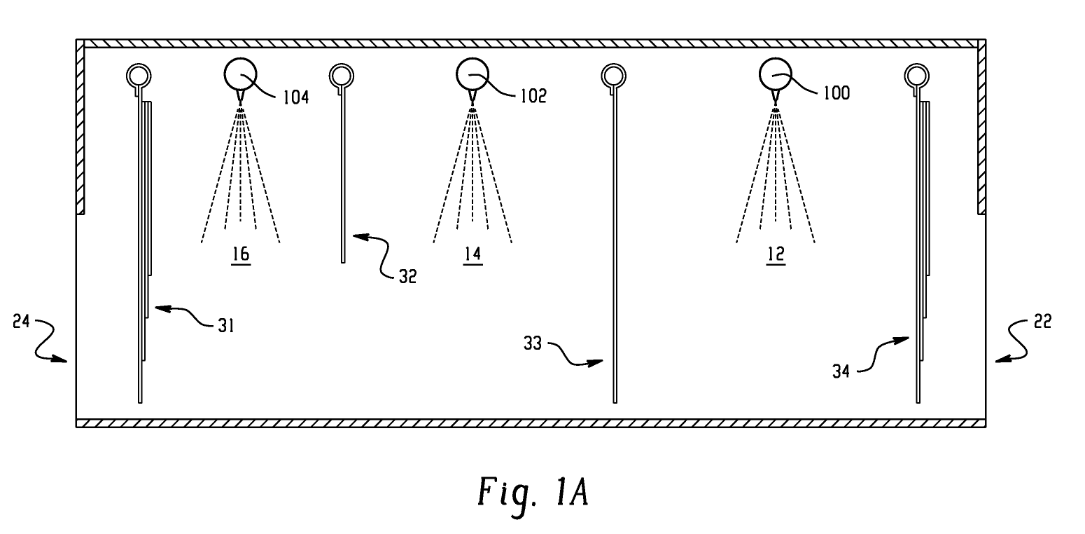

Referring to FIG. 1, a warewasher housing 10 may include a conveyance path 20 and multiple stations for washing: a power-wash station 12, a power-rinse station 14, and a final rinse station 16. Each station 12, 14, 16 includes nozzles for spraying liquid on ware passing therethrough (e.g., spray arms 100, 102 and 104 with nozzle openings therein). Any suitable conveyor mechanism may be used to convey ware along the path. Stations are separated by curtains. In one embodiment, a long curtain 31 is located at the outfeed 24 of the path 20, retaining water, vapor, and heat that might otherwise escape the warewasher housing 10. A short curtain 32 separates the final rinse station 16 from the power-rinse station 14. A curtain 33 separates the power-wash station 12 from the power-rinse station 16. A long curtain 34 is located at the infeed 22 of the path 20, again retaining water, vapor, and heat that might otherwise escape the warewasher housing 10. It is recognized that various machine configurations are possible with different numbers and types of spray zones or stations.

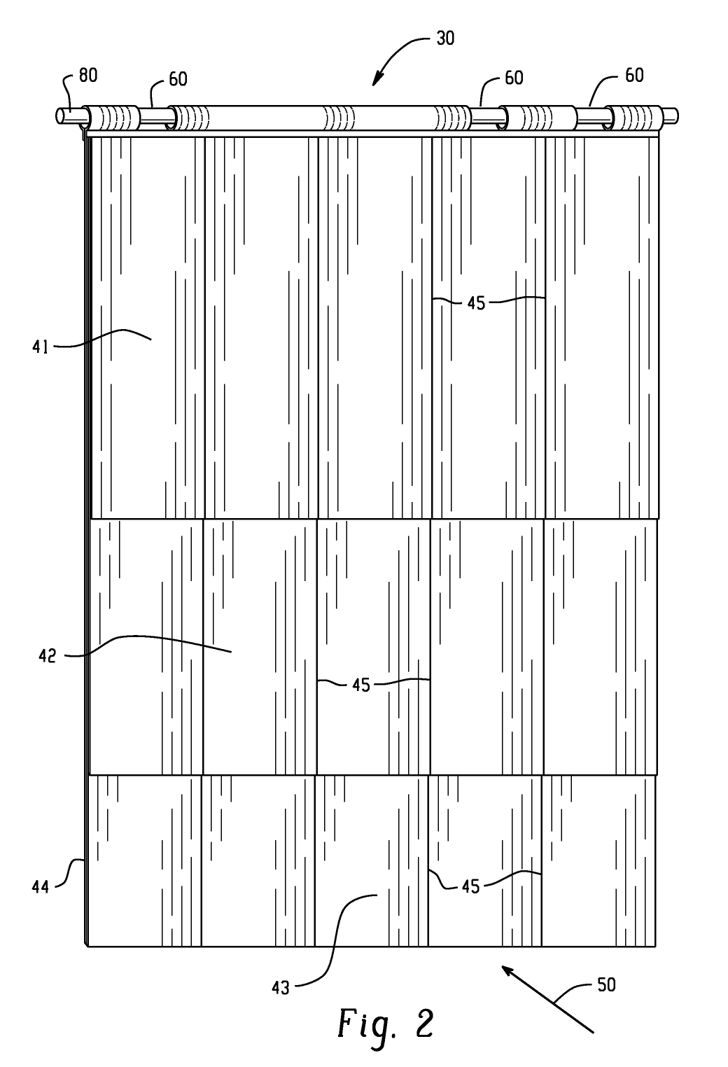

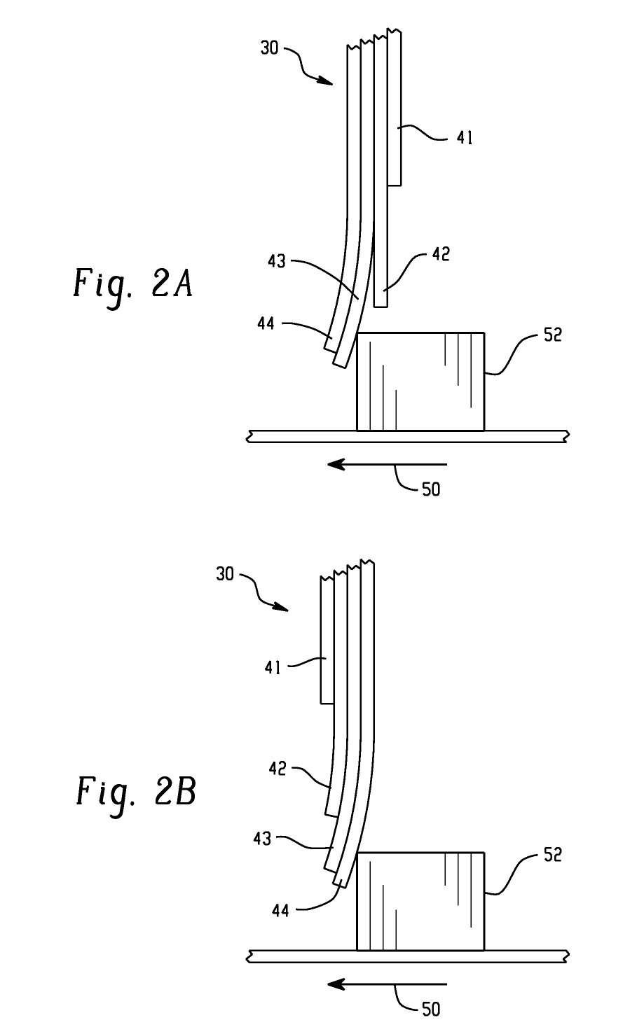

One embodiment of a long curtain 30, such as the curtains 34, 31 located at the infeed and outfeed in FIG. 1, is shown in FIG. 2. Four layers 41, 42, 43, and 44 are shown. Front layer 41 is shorter than layer 42, which in turn is shorter than layer 43 and back layer 44 (which in this embodiment are the same length). The top section of the curtain material is looped to form a receiving space for a curtain rod 80, with sections of the material cut out to form openings 60 for hanging the curtain 30 as described below and shown in FIG. 4A. Slits 45 are located in each layer, but are staggered in position between layers. An arrow 50 is used to show the direction in which wares should come into contact with the curtain to achieve proper curtain function.

When ware is conveyed past the curtain 30 in the correct direction 50, it contacts a number of layers of the curtain according to the ware height. For example, a tray of silverware might only be tall enough to contact layers 43 and 44, which are the longest. Those layers are pushed toward the back of the curtain 30, while layers 42 and 41 remain in place. A taller tray, such as for dishware, might contact layer 42 as well, leaving only front layer 41 in place. The layer or layers that remain in place continue to perform the primary function of the splash curtain 30, which is to retain water, vapor, and heat rather than allow them to pass the location where the curtain 30 is hung.

FIGS. 2A and 2B illustrate the difference between the ware interaction when the curtain is hung correctly and when the curtain 30 is hung backwards. FIG. 2A shows a short object 52 passing along the conveyance path in the correct direction, contacting and moving layers 43 and 44 while layers 42 and 41 remain in place. FIG. 2B in contrast shows the same short object 52 passing along the conveyance path with the curtain 30 reversed. When the object contacts back layer 44, in this direction it also moves layers 43, 42, and 41. None of the layers are left undisturbed to properly carry out the curtain's barrier function.

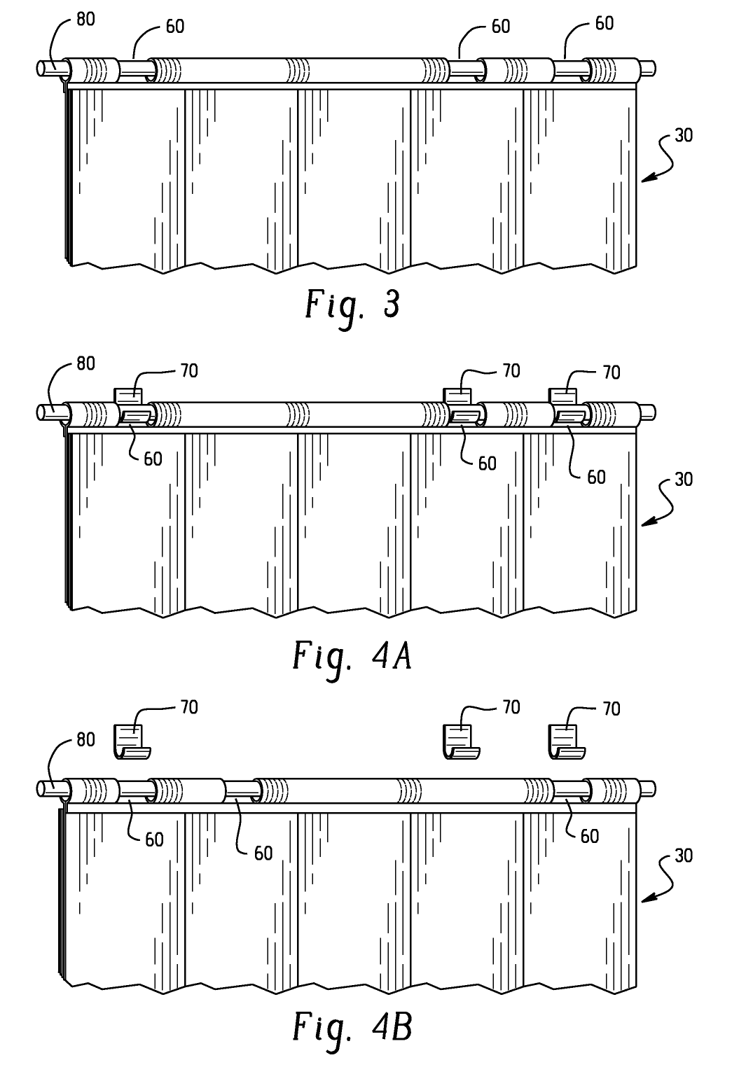

As shown in FIGS. 3-4, however, the top connection part of the long curtain 30 is not symmetrical. Instead, the openings 60 are spaced asymmetrically. The openings 60 may be defined by the bottom portion of the curtain rod 80 and the edge of the curtain material at each cut out section as shown, although other embodiments are possible. The connectors 70 are located within the machine and spaced such that they fit easily into the openings 60 when the curtain is hung correctly, as shown in FIG. 4A. However, as shown in FIG. 4B, the connectors will not fit into the openings when the orientation of the curtain 30 is reversed. This prevents the user from inadvertently hanging the curtain 30 in a reversed orientation where it functions differently.

Returning to FIG. 1, a short curtain 32 may be used internally in order to provide a barrier without contacting the ware at all. This may be necessary so that the ware are not covered when entering a next station. Short curtain 32 may contain fewer layers than long curtain 30 and may be symmetric. However, short curtain 32 does not function to provide the same barrier to retain water, vapor, and heat as does a long curtain. Short curtain 32 does not provide the expected amount of retention if hung in a location designed for a long curtain, such as the infeed 22 or outfeed 24. Similarly, a long curtain 30 may cover the ware in an undesirable way if hung in a location designed for a short curtain 32, such as between the power-wash and power-rinse stations 12 and 14 in FIG. 1.

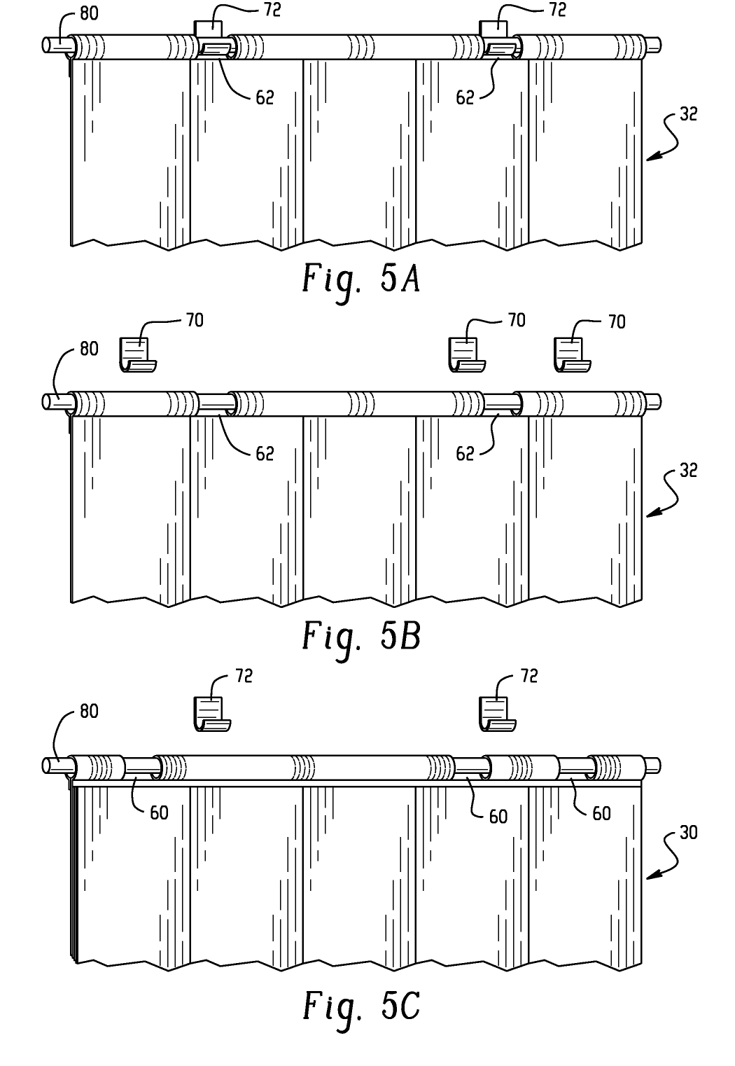

An embodiment of a short curtain 32 is shown in FIG. 5. The short curtain 32 may include openings 62 which are spaced symmetrically. Connectors 72 are spaced such that they fit easily into openings 62 when the curtain is hung, as shown in FIG. 5A. However, this configuration of openings and connectors is incompatible with the design used for the long curtain 30. As shown in FIG. 5B, connectors 70 spaced for the long curtain will not fit into openings 62 of the short curtain. Similarly, connectors 72 spaced for the short curtain will not fit into openings 60 of the long curtain. This prevents the user from inadvertently hanging the long and/or short curtains in the wrong locations where they function differently.

As is shown in FIG. 1 with curtains 31 and 34, multiple curtains at locations where the same curtain function is appropriate may be of identical design. Where juxtaposition of curtains will not effect their ability to function, multiple identical curtains may be used, and multiple identically spaced sets of connections mounted at different locations on the warewasher. Similarly, where curtain function is not inhibited by reversed orientation, connections may be symmetrical and allow for the curtain to be hung in either orientation, as illustrated with short curtain 32.

The curtain functions as a barrier to water, vapor, and heat while permitting ware to pass through. In one embodiment, the curtain material is a flexible material that is substantially waterproof and insulating, such as thermoplastic.

It is to be clearly understood that the above description is intended by way of illustration and example only and is not intended to be taken by way of limitation. Other variations are possible.

What is claimed is:

1. A conveyer warewasher comprising:
a housing have at least one internal station for spraying ware with liquid;
a conveyer for moving ware through the housing along a conveyance path having an infeed end and an outfeed end;
a removable curtain hung across the conveyance path, the curtain having a front side facing the infeed end and a back side facing the outfeed end, the front and back sides of the curtain being functionally distinct such that if the curtain is arranged with the front side facing the outfeed end, the curtain will function differently than with the front side facing the infeed end;
the curtain further having a top part configured to interact with connectors on the warewasher in order to removably attach the curtain to the warewasher, the top part and connectors arranged and configured such that, when the curtain is positioned with the front side facing the outfeed end, the connectors do not interact with the top part in a manner that enables attachment of the curtain, thereby preventing attachment of the curtain in a backward configuration.

2. The conveyer warewasher of claim 1, wherein the curtain is a first curtain removably attached at a first location, the warewasher further comprising:
a second removable curtain hung across the conveyance path at a second location, the second curtain being functionally distinct from the first curtain,
wherein the second curtain is configured such that it cannot be hung at the first location;
wherein the first curtain is configured such that it cannot be hung at the second location.

3. The conveyor warewasher of claim 2 wherein the first location is adjacent one of an entry opening or an exit opening of the housing, the second location is internal of the housing.

4. The conveyor warewasher of claim 3 wherein a length of the second curtain is shorter than a length of the first curtain.

5. The conveyor warewasher of claim 2, further comprising:
a third curtain hung across the conveyance path at a third location, the third curtain having a configuration identical to that of the first curtain.

6. The conveyer warewasher of claim 1, wherein the first removable curtain contains multiple layers of varying length, the shortest layer being the layer closest to the front of the curtain, such that moving ware can disturb one or more of the longer layers while leaving one or more of the shorter layers in place.

7. The conveyor warewasher of claim 6, wherein each layer of the first removable curtain is slitted vertically, the vertical slits being located in different horizontal locations on adjacent layers.

8. The conveyor warewasher of claim 1 wherein the connectors are elongated hanger brackets.

9. A splash curtain for a conveyor warewasher and configured for orientation specific installation, comprising:
a top connection part from which flexible curtain material is hung to extend down vertically in order to create a water and heat barrier, the flexible curtain material is substantially waterproof and insulating;
a front side and a back side functionally distinct from the front side, so that the curtain will function differently if it is hung with the front and back sides reversed;
the top connection part of the curtain includes multiple slot-type openings for receiving hanger brackets, the multiple slot-type openings arranged asymmetrically along a width of the curtain such that: (i) when the curtain is facing front side forward the mutltiple-slot type openings are located in a first connection arrangement and (ii) when the curtain is facing back side forward the multiple slot-type opening are located in a second connection arrangement that is different than the first connection arrangement.

10. The splash curtain of claim 9 wherein the top connection part includes a rod for positioning over hanger brackets of a warewasher, and the curtain material includes cut-outs so that the multiple slot-type openings are defined between the rod and the curtain material.

11. The splash curtain of claim 10 further wherein the curtain material includes multiple layers of varying length, the shortest layer being the layer closest to the front of the curtain, such that an item contacting the front of the curtain can disturb one or more of the longer layers while leaving one or more of the shorter layers in place.

12. The splash curtain of claim 11, wherein each layer of the curtain material is slitted vertically, the vertical slits being located in different horizontal locations on adjacent layers.

13. The splash curtain of claim 12, wherein the curtain material comprises four layers of thermoplastic material with three graduated lengths, the layers being arranged such that they increase in length from the front to the back of the curtain, such that an item contacting the front of the splash curtain during warewasher operation can push two layers while leaving two layers in place or can push three layers while leaving one layer in place, depending on the item's height.
